(19) United States
(12) Patent Application Publication
(10) Pub. No.: US 2009/0025748 A1
(43) Pub. Date: Jan. 29, 2009

(54) RIGHT ANGLE DENTAL FLOSSING DEVICE

(76) Inventor: Banning Gray Lary, Miami, FL (US)

Correspondence Address: MCHALE & SLAVIN, P.A., 2855 PGA BLVD, PALM BEACH GARDENS, FL, 33410, US

(21) Appl. No.: 12/176,751

(22) Filed: Jul. 21, 2008

Related U.S. Application Data
(63) Continuation-in-part of application No. 12/056,074, filed on Mar. 26, 2008.
(60) Provisional application No. 60/920,301, filed on Mar. 27, 2007.

(51) Int. Cl. A61C 15/04

(52) U.S. Cl. 132/324

(57) ABSTRACT

A polyaxial flossing device constructed to provide a flossing portion with a plurality of axes of pivotal movement relative to a handle which can assume a straight or intermittently-angled shape position is described. The dental flossing device is formed by interconnecting a flossing portion and a handle portion by a universal joint to define a polyaxial joint. The universal joint includes a substantially spherical end and a substantially spherical appendage extending outwardly and sized to cooperate with the spherical cavity. Such construction and arrangement provides universal movement between the flossing and handle portions. The dental flossing device further has at least one resilient member extending between the flossing portion and handle portion of the invention, providing resistance to the pivoting flossing portion with respect to the handle portion.

### CROSS REFERENCE TO RELATED APPLICATION

This application is a continuation-in-part of U.S. patent application Ser. No. 12/056,074, filed Mar. 26, 2008, which claims priority under 35 U.S.C. § 119(e) to U.S. Provisional Application 60/920, 301, filed on Mar. 27, 2007, the contents of both are herein incorporated by reference.

### FIELD OF INVENTION

The invention relates to oral hygiene, more specifically to a polyaxial dental flossing device constructed to provide a flossing portion with a plurality of axes of pivotal movement with regard to a handle.

### BACKGROUND OF THE INVENTION

Proper oral hygiene is considered paramount in the development and maintenance of a strong and healthy mouth. Professional dental care, regular cleanings, and proper and effective teeth cleaning removes the sticky, colorless bacteria-produced biofilm known as plaque. Removal of plaque through proper cleaning prevents formation of cavities and periodontal diseases. Failure to remove plaque on a regular basis results in the build-up and thickening of the biofilm and increased risk of developing dental diseases such as gingivitis. Left untreated, gingivitis can result in the more advanced disease of periodontitis. Progression of periodontitis ultimately results in tooth loss.

Proper brushing technique is considered one of the most effective daily treatments to maintain healthy teeth and gums. In addition to proper brushing techniques, it is well established that a proper oral hygiene strategy must include use of dental floss massaged along the gum line and areas between the teeth. Proper flossing techniques have the benefit of removing food from areas a toothbrush can not reach, preventing tooth decay between the teeth. Flossing removes plaque from between the teeth and gum line where periodontal disease often begins. In addition to preventing gum disease, regular flossing guards against bad breath and keeps teeth clean and healthy looking.

Although each individual may have their own technique, flossing techniques generally include placing a predetermined amount of dental floss positioned around the middle fingers of each of the user's hands. The floss is pinched between the index finger and thumb and kept taunt between the fingers. Index fingers are used to guide the floss between the areas of the lower teeth. The floss is gently guided between the teeth using a back and forth motion. The floss is slide up and down against the tooth surface and under the gum line. Certain areas of the mouth are often hard to reach, resulting in developing pain in the hands and inadequate plaque removal. To address these problems, dental flossing devices are often used in lieu of using the finger technique.

One of the problems associated with the dental flossing devices is the rigid handle. This rigidity often results in the stretching of the mouth when placing the flossing portion between teeth associated with the lateral side. For instance, when flossing the right side of the mouth individuals tend to extend the wall of the right lateral cheek. The placement of the flossing portion tends to cause stretching of the lateral cheek wall, resulting in minor injuries to the right angle of the mouth. Minor injury of the mouth is further associated with the left lateral side. Right handed individuals have difficulty flossing the areas of the molar teeth associated with the left side of the face and the inside of the molar teeth associated with the right side of the face. Left handed individuals have the opposite problem, having difficulty flossing the area between the molar teeth associated with the right side of the face and the inside of the molar teeth associated with the left side of the face.

A dental flossing device that is not permanently straight and has the capability to bend at various angles along a plurality of axes of motion would alleviate the problem. Thus, there is a need for an improved dental flossing device that provides a flossing portion having at least two axes of pivotal movement relative to a handle portion to provide contact with hard to reach areas without causing injury to other portions of the mouth.

### DESCRIPTION OF THE PRIOR ART

Flossing as part of dental hygiene strategy has been proven to be very helpful. The actual technique of flossing can be difficult with such difficulty resulting in individuals not performing this vital cleaning technique. Techniques wrapping dental floss around an individual's fingers and applying the floss to the teeth and gums can not only be painful to the user but also difficult in reaching certain areas of the mouth. Such problems results in individuals eliminating flossing from their oral hygiene strategy, leaving the user more susceptible to tooth decay and other dental diseases. Dental devices have been developed allowing dental floss to be attached to a device allowing the user to floss without wrapping the dental floss around any of the user's fingers. These devices have taken many shapes and designs, including U.S. Design Pat. D386,617, U.S. Design Pat. D521,189, U.S. Design Pat. D532,159, and U.S. Design Pat. D539,479.

One of the problems associated with these types of devices was the lack of capability to bend or move the handle in order to effectively floss hard to reach areas. The user had no ability to bend or manipulate the device to reach certain areas of the mouth, forcing the user to extend the cheek with the apparatus. Such extension of the cheek often causes injury to the mouth. Attempts to address this problem resulted in flossing devices providing a user with limited movement.

U.S. Pat. No. 4,706,694 discloses a limited adjustable flossing device. The device has a handle portion and a head portion. The head portion was designed to hold the dental device and pivot relative to the handle about a pivot. While this device allows the head portion limited movement, the device lacks a polyaxial joint mechanism which provides for multiple axes movement.

U.S. Pat. No. 5,125,424 discloses a dental flossing device that provides for a flossing element supported by a handle in a pivoting manner about a fixed axis. The device does not include a polyaxial joint. While this device provides for movement of the flossing element, the movement is restricted to the flossing element itself and limited along the pivot axis. Since movement of the handle is not possible, the user would be forced to insert most of the apparatus into the mouth while attempting to clean certain areas of the teeth resulting in extension of the cheeks and possible damage to the mouth.

U.S. Pat. No. 7,146,988 discloses a flossing apparatus capable of movement along a hinge. The movement disclosed is limited to bending of the flossing head in one direction and not more than 90 degrees. The '988 invention, however, lacks a polyaxial connection and as a result, movement of the flossing element relative to the handle suffers from the same shortcoming as the other prior art devices in that movement is limited along a single axis. As a result, the handle portion remains fixed and makes it difficult to reach some sections of the mouth without extending the lateral walls of the cheek

U.S. Patent Application 2007/0157946 describes a flexible dental floss applicator which is adjustable to various angles. While the flossing element described in the '946 application may provide for movement at various angles, such movement is limited along a single axis. Unlike the instant invention, the '946 application does not have a polyaxial connection providing a flossing element with a plurality of axes of pivotal movement.

Therefore, what is needed in the art is a dental flossing device that has axial rotation and/or lateral bending in varying angles and degrees, including bending at angles of 90 degrees or greater.

### SUMMARY OF THE INVENTION

The present invention is directed to a tooth flossing device and more particularly a polyaxial dental flossing device that can assume a straight or intermittently angled bent shape. The dental flossing device is formed by interconnecting two portions by a universal joint. A flossing portion is defined by a first end and a second end. The first end has a flossing element and the second end has a first portion of the universal joint. The dental flossing device also has a handle portion having a first end and a second end. The first end of the handle portion has a second portion of the universal joint. The ends of the universal joints are arranged to cooperate with each other to provide multiple axes of movement. The dental flossing device further has at least one resilient member extending between the dental flossing device portion and handle portion of the invention which provides resistance to the pivoting dental flossing device portion with respect to the handle.

As described herein, the term polyaxial joint is understood to include, albeit not limited to, a universal joint, a constant velocity joint, Cardan joint, a Hardy-Spicer joint, a Thompson coupling, a rag joint, a gimbal joint, and an elastic coupling.

As described herein, a plurality of axes of pivotal movement includes pivotal movement in one or more axes, 360 degree axial rotation, and lateral bending at varying degrees including 90 degrees or greater.

Accordingly, it is a primary objective of the instant invention to provide a polyaxial dental flossing device having a universal joint connection that provides movement of a dental flossing portion relative to the handle portion.

It is a further objective of the instant invention to provide a dental flossing device having a universal joint connection that defines a polyaxial joint providing a flossing portion with a plurality of axes of pivotal movement relative to the handle portion.

It is yet another objective of the instant invention to provide a dental flossing device having a universal joint connection that defines a polyaxial joint providing a flossing portion with a plurality of axes of pivotal movement relative to the handle portion which provides a user the capability to floss in the straight or intermittently-angled positions.

It is a further objective of the instant invention to provide a polyaxial dental flossing device having a universal joint connection that defines a polyaxial joint between the floss and handle portions permitting axial rotation and/or lateral bending in varying angles and degrees.

It is a still further objective of the invention to provide a polyaxial dental flossing device which includes at least one resilient member constructed and arranged to provide a biasing force which provides resistance to pivoting of the flossing portion with respect to the handle portion between a straight and bent position.

Other objects and advantages of this invention will become apparent from the following description taken in conjunction with any accompanying drawings wherein are set forth, by way of illustration and example, certain embodiments of this invention. Any drawings contained herein constitute a part of this specification and include exemplary embodiments of the present invention and illustrate various objects and features thereof.

### BRIEF DESCRIPTION OF THE FIGURES

FIG. 1A represents a side view of an embodiment of the dental flossing device indicating the flossing portion, handle portion, universal joint and resilient member;

FIG. 1B is a perspective view of an embodiment of the dental flossing device;

FIG. 1C represents a side view of the flossing portion;

FIG. 1D represents a side view of the handle portion;

FIG. 2 is a back view of the dental flossing device;

FIG. 3A is a transverse view of the dental flossing device;

FIG. 3B is an embodiment of the first portion of the universal joint.

FIG. 3C is an embodiment of the second portion of the universal joint;

FIG. 4 shows the dental flossing device in the bent position; and

FIG. 5 shows the connection between the first and second portions of the universal joint defining a polyaxial joint in the bent position.

### DETAILED DESCRIPTION OF THE INVENTION

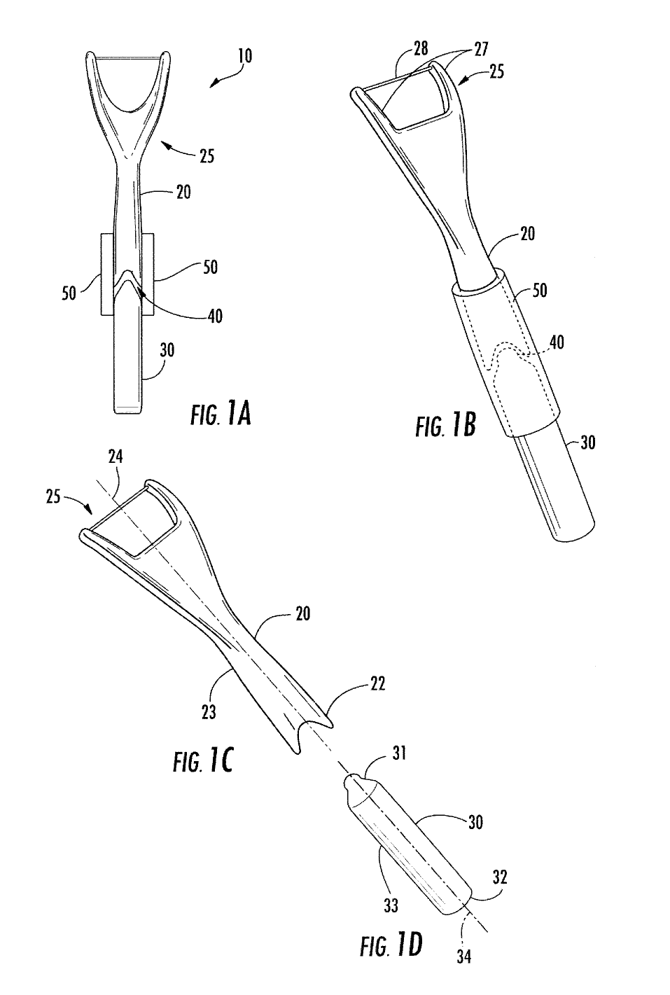

The polyaxial dental flossing device 10, shown in FIGS. 1A and 1B, has four major components, a flossing portion 20, a handle portion 30, a polyaxial, e.g. a universal joint 40, and a resilient polymeric member 50. As seen in FIG. 1C, the flossing portion 20 has a first end 21 and a second end 22, an outer surface 23 and a first longitudinal centerline 24. The first end 21 of the flossing portion 20 has a flossing element 25. The second end 22 includes a portion of a universal joint 40. Although the joint may be located at any position, in one embodiment, the location is between about 4 and 4.5 inches from the tip of the first end 21 of the flossing portion 20. In order to provide greater stability when using, the flossing portion 20 may also have an enlarged, depressed area 26 positioned proximate to the first end 21, see FIG. 2.

As illustrated in FIG. 1B, the flossing element 25 generally has two arms 27 extending from the flossing portion. Flossing element 25 is constructed and arranged so as to receive and house dental floss 28. The flossing element can be designed, arranged and constructed in any shape, such as C-shape or Y-shape, known to one of skill in the art that allows housing the dental floss and application of the dental floss to the teeth and gums. The flossing portion 20 and/or flossing element 25 may be straight, angled or arranged in any other position. In addition, flossing portion 20 may be designed, constructed and arranged such that flossing element 25 is permanently attached to the flossing portion. In this embodiment, the device can be used as a disposable, single-use device or be constructed to allow the user to replace dental floss 28 after each use. Alternatively, flossing element 25 may be designed, constructed and arranged such that the flossing element is removably attached to the flossing portion 20 or handle portion 30, which may also be designed and constructed to receive or be inserted into the flossing element 25. In this manner, the user simply replaces the removable flossing element after each use. This configuration further allows the user the ability to attach various flossing element designs or shapes to the flossing device.

As shown in FIG. 1D, the handle portion 30 has a first end 31 and a second end 32, an outer surface 33 and a second longitudinal centerline 34. The outer surface 33 defines a grip. The first end 31 includes a portion of the polyaxial joint 40. The polyaxial joint 40 is constructed and arranged to provide cooperation between a first portion of the polyaxial joint associated with the second end 22 of the flossing portion 20 and first end 31 of handle portion 30. This arrangement defines a polyaxial joint constructed and arranged to provide the flossing portion 20 with at least two axes of pivotal movement with respect to the handle portion 30.

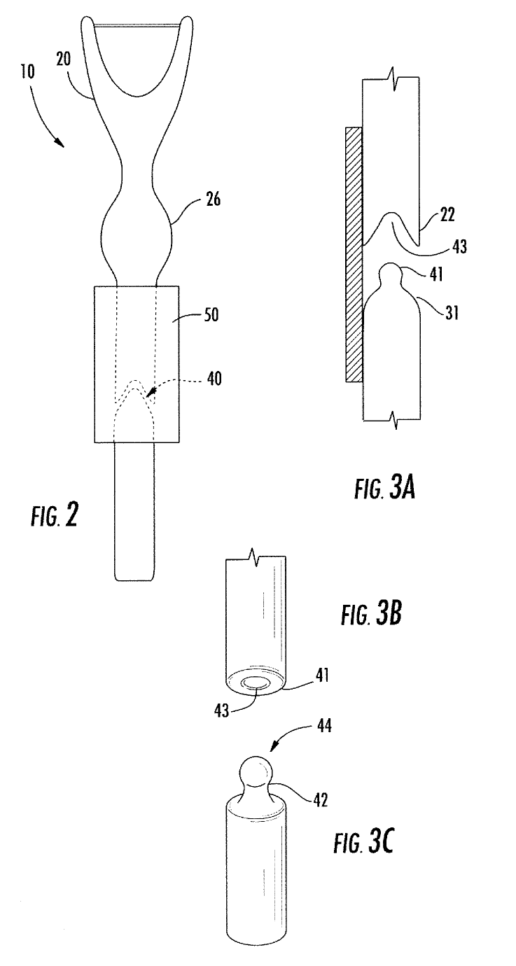

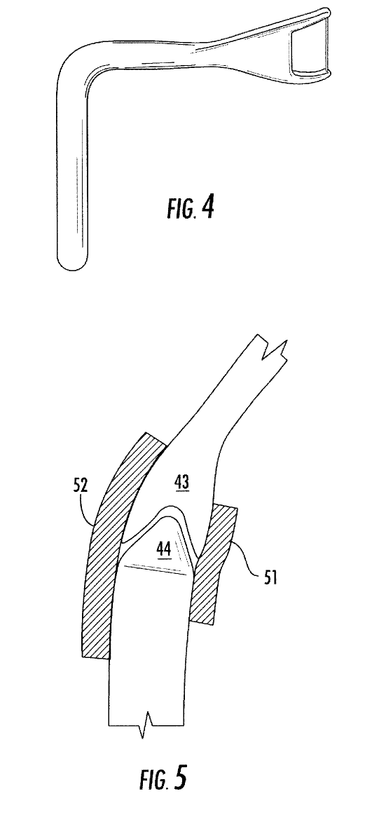

FIGS. 3A, 3B, and 3C, illustrates the polyaxial joint 40 of the polyaxial dental flossing device 10 having a first portion 41 and a second portion 42. The first portion 41 includes a substantially spherical cavity 43 aligned along the first longitudinal axis 24. In a particular embodiment, the substantially recessed spherical cavity could further have a reverse frustoconical shape. The second portion 42 of the universal joint 40 includes a substantially spherical appendage 44 extending outwardly from the first end 31 of the handle portion 30 and aligned substantially along said second longitudinal axis 34. In a particular embodiment, the substantially spherical appendage could further have a frustoconical shape. The substantially spherical appendage 44 is sized to cooperate with the substantially spherical cavity 43 to provide universal movement between the flossing portion 20 and the handle portion 30. Not wanting to limit the invention to a specific embodiment, the first and second ends of the universal joint 40 as shown in the any of the figures could be reversed so that the substantially spherical appendage 44 would be located at the second end 22 of the flossing portion and the substantially spherical cavity 43 would be located at the first end 21 of the handle portion 30. The first and second portions of the universal joint may be molded into the second end 22 of the head portion 20 and/or the first end 31 of the handle portion 30.

Although FIGS. 3A, 3B and 3C describe a single embodiment of the polyaxial joint having mostly a spherical appendage sized to cooperate with a substantially spherical cavity, as used herewith, the polyaxial joint is not limited to a particular embodiment. The polyaxial joint may be selected from numerous connections or joints which provide at least two planes or axes of pivotal movement, including a gimbal joint, an elastic coupling and a rag joint. In addition, the polyaxial joint can be selected from any type of universal joint. Universal joints generally are joints placed in a rod or shaft that allows for the bending of the rod or shaft in any direction. The universal joint generally contains hinges located close together and oriented at 90 degrees relative to each other. Simple universal joints may be composed of two yokes, a center bearing block and two pins that run through the center bearing block at right angles to each other, see for example Universal Joint, Curtis Universal Joint Co., Inc, Springfield, Mass. In addition, the polyaxial joint may be selected from a Cardan Joint, a simple, flexible coupling with two yokes and a four point center cross, or the like, and a Hardy-Spicer Joint, both of which are well known in the art. In other embodiments, the polyaxial joint may be selected from constant-velocity (CV) joints, such as the Tripod (or Triax) or ball-type (such as the Rzeppa joint). An additional embodiment for the polyaxial joint may include a Thompson coupling.

The construction of the polyaxial joint provides polyaxial movement which allows movement of the flossing portion 20 relative to the handle portion 30 allowing the floss portion 20 intermittently-angled movements along one axis of motion in either the forward and backward motion. In addition, the nature of the connection further allows intermittently-angled movement along a plurality of axes of pivotal movement providing a user 360 degree freedom of rotation. With this construction, the user's hand can easily provide the force and stabilization necessary to bend the dental flossing device. Rotating and bending the floss portion 20 relative to the handle portion 30 to varying degrees and angles, see FIG. 4, provides the floss portion contact with hard to reach areas, such as the lateral, medial, and back teeth areas.

The polyaxial dental flossing device of the instant invention further includes at least one resilient member 50 extending between the second end 22 of the flossing portion 20 and the first end 31 of the handle portion 30. The resilient member 50 may be constructed and arranged to provide resistance to pivoting of the flossing portion 20 with respect to the handle portion 30. Resilient member 50 may be a sleeve constructed and arranged to engage the outer surfaces 23 and 33 of the flossing portion 20 and handle portion 30 respectively. Although not limiting the invention to a particular embodiment, the term resilient member is nevertheless understood to include any flexible or elastomeric material which can be constructed to cover any portion of the dental flossing device 10. Additionally, as described in FIG. 5, depending on the direction of bending or rotation, the resilient member 50 can be compressed on one side 51 and extended on the opposite side 52, producing a cushioning effect and a tendency to return to a state of equilibrium. The resilient member 50 could also be constructed to cover additional areas of the handle or the flossing portions.

The polyaxial dental flossing device 10 provides the user with the ability to floss within various areas between an individual's teeth by varying the angle of the floss portion relative to the handle portion. In a particular method of using the flossing device to floss an individual's teeth, the individual applies the flossing element to a particular area between the teeth or along the gums. Using either hand, the three lateral fingers are placed towards the distal ends of the handle portion 30 along the outer surface 33 which forms a grip. The index finger and thumb support the proximal portion of the floss portion 20. In order to form more stable grasp and properly manipulate the bending of the dental flossing device, the thumb engages the enlarged, recessed section 26 of the floss portion. While firmly holding the head and handle portions, pressure is applied to the portions allowing the dental flossing device to assume either a straight or intermittently angled position.

All patents and publications mentioned in this specification are indicative of the levels of those skilled in the art to which the invention pertains. All patents and publications are herein incorporated by reference to the same extent as if each individual publication was specifically and individually indicated to be incorporated by reference.

It is to be understood that while a certain form of the invention is illustrated, it is not to be limited to the specific form or arrangement herein described and shown. It will be apparent to those skilled in the art that various changes may be made without departing from the scope of the invention and the invention is not to be considered limited to what is shown and described in the specification and any drawings/figures included herein.

One skilled in the art will readily appreciate that the present invention is well adapted to carry out the objectives and obtain the ends and advantages mentioned, as well as those inherent therein. The embodiments, methods, procedures and techniques described herein are presently representative of the preferred embodiments, are intended to be exemplary and are not intended as limitations on the scope. Changes therein and other uses will occur to those skilled in the art which are encompassed within the spirit of the invention and are defined by the scope of the appended claims. Although the invention has been described in connection with specific preferred embodiments, it should be understood that the invention as claimed should not be unduly limited to such specific embodiments. Indeed, various modifications of the described modes for carrying out the invention which are obvious to those skilled in the art are intended to be within the scope of the following claims.

I claim:

1. A dental flossing device comprising:
a flossing portion, said flossing portion having a first end and second end, an outer surface and a first longitudinal centerline, said first end of said flossing portion having a flossing element, said second end including a first portion of a polyaxial joint;
a handle portion, said handle portion having a first end and a second end, an outer surface and a second longitudinal centerline, said outer surface defining a grip, said first end including a second portion of said polyaxial joint, said second portion of said polyaxial joint being constructed and arranged to cooperate with said first portion of said polyaxial joint to define a polyaxial joint constructed and arranged to provide said flossing portion with at least two axes of pivotal movement with respect to said handle portion.

2. The polyaxial dental flossing device according to claim 1 including at least one resilient member extending between said second end of said flossing portion and said first end of said handle portion, said at least one resilient member being constructed and arranged to provide resistance to pivoting said flossing portion with respect to said handle portion.

3. The polyaxial dental flossing device according to claim 2 wherein said at least one resilient member is a sleeve constructed and arranged to engage said outer surface of said flossing portion and said handle portion.

4. The polyaxial dental flossing device according to claim 1 wherein said first portion of a polyaxial joint includes a substantially spherical cavity aligned along said first longitudinal axis and said second portion of a polyaxial joint includes a substantially spherical appendage extending outwardly from said first end of said handle portion and aligned substantially along said second longitudinal axis, said spherical appendage sized to cooperate with said spherical cavity to provide universal movement between said floss portion and said handle portion.

5. The polyaxial dental flossing device according to claim 4 including at least one resilient member extending between said second end of said flossing portion and said first end of said handle portion, said at least one resilient member being constructed and arranged to provide resistance to pivoting said flossing portion with respect to said handle portion.

6. The polyaxial dental flossing device according to claim 5 wherein said at least one resilient member is a sleeve constructed and arranged to engage said outer surface of said flossing portion and said handle portion.

7. The polyaxial dental flossing device according to claim 6 wherein said flossing portion includes an enlarged, depressed area positioned above the polyaxial joint and proximal to said first end of said floss portion.

8. The polyaxial dental flossing device according to claim 7 wherein said flossing element is removably attachable to said flossing portion.
